(19) United States
(12) Patent Application Publication
(10) Pub. No.: US 2025/0390259 A1
(43) Pub. Date: Dec. 25, 2025

(54) SERVER, NON-TRANSITORY COMPUTER-READABLE RECORDING MEDIUM STORING COMPUTER-READABLE INSTRUCTIONS FOR SERVER AND CONTROL METHOD FOR SERVER

(71) Applicant: BROTHER KOGYO KABUSHIKI KAISHA, Nagoya (JP)

(72) Inventor: Yushi ICHIKAWA, Nagoya (JP)

(21) Appl. No.: 19/245,799

(22) Filed: Jun. 23, 2025

(30) Foreign Application Priority Data
Jun. 25, 2024 (JP) 2024-101867

(51) Int. Cl. G06F 3/12

(52) U.S. Cl. CPC G06F 3/1229; G06F 3/1204; G06F 3/1288

(57) ABSTRACT

A server may include a controller configured to: execute a first providing process by using first-type information stored in a memory, wherein the first providing process is a process for providing a first service for a first printer identified by first identification information included in the first-type information; and in a case where second-type information different from the first-type information is stored in the memory in association with the first-type information, store benefit granting information in the memory in association with the first-type information, wherein the benefit granting information indicates that a benefit has been granted to an user of the first service.

### REFERENCE TO RELATED APPLICATION

This application claims priority to Japanese Patent Application No. 2024-101867 filed on Jun. 25, 2024. The entire content of the priority application is incorporated herein by reference.

### BACKGROUND ART

A service for shipping consumable articles for printers is known. When a remaining amount in a consumable article used for printing becomes equal to or less than a predetermined threshold, a printer determines whether the printer has subscribed to the service. When the printer determines that it has already subscribed to the service, a delivery of a new consumable article is requested, whereas when the printer determines that it has not subscribed to the service, a screen that prompts subscription to the service is displayed.

### SUMMARY

In the technology above, once a user subscribed to the service, the service is merely continued to be provided to the user until the subscription is terminated. This is insufficient in terms of promoting user recognition on an appeal of the service. The disclosure herein provides a technology for improving convenience for a user using a service while promoting user recognition on the appeal of the service.

A server disclosed herein may include a controller. The controller may be configured to execute a first providing process by using first-type information stored in a memory, wherein the first providing process is a process for providing a first service for a first printer identified by first identification information included in the first-type information; and in a case where second-type information different from the first-type information is stored in the memory in association with the first-type information. The controller may be configured to store benefit granting information in the memory in association with the first-type information, wherein the benefit granting information indicates that a benefit has been granted to a user of the first service.

According to the configuration above, a benefit is granted to the user in exchange for storing the second-type information. The user can use the benefit to use the first service more conveniently. User recognition on an appeal of the service can thus be promoted.

Computer-readable instructions for the above server and a non-transitory computer-readable recording medium storing the computer-readable instructions are also novel and useful. Further, methods of controlling the above server are also novel and useful.

### BRIEF DESCRIPTION OF DRAWINGS

FIG. 1 is a schematic diagram of a communication system.

FIG. 2 is a block diagram of a service server.

FIG. 3 is a block diagram of an account server.

FIG. 4 is a sequence diagram of a process for registering optional information.

FIG. 5 is a sequence diagram of a process for providing a service and a process for granting a benefit.

FIG. 6 is a sequence diagram of a process for granting a benefit.

FIG. 7 is a schematic diagram of a communication system.

FIG. 8 is a sequence diagram of a process for granting a benefit.

### DESCRIPTION

### First Embodiment

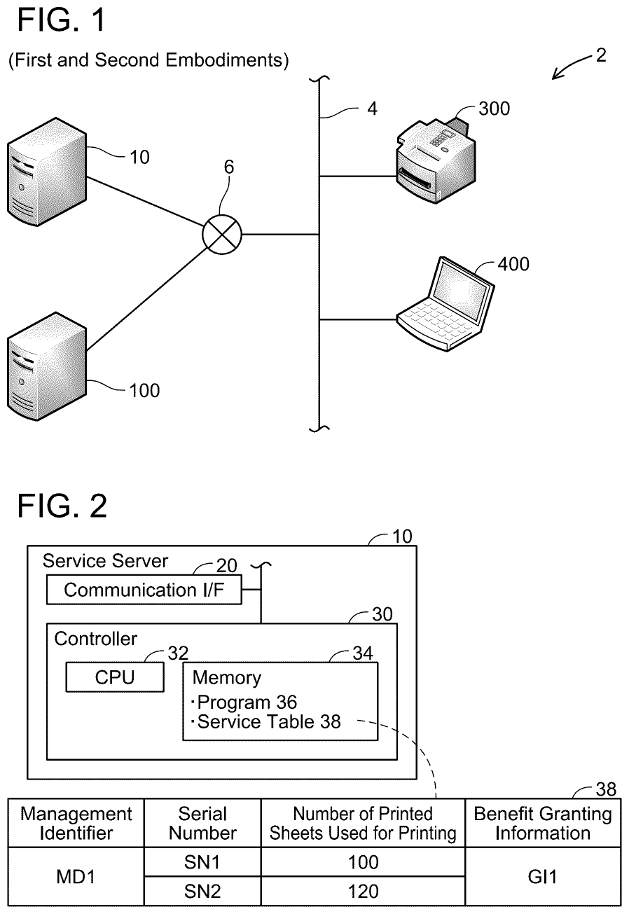

### Configuration of Communication System 2: FIG. 1

A communication system 2 comprises a service server 10, an account server 100, a printer 300, and a terminal device 400. The terminal device 400 may be, for example, a laptop PC, a smartphone, a tablet terminal, or a desktop PC. The printer 300 is a peripheral device of the terminal device 400 and has a print function. The printer 300 may be a multifunctional device having multiple functions, such as a scan function, in addition to the print function.

The terminal device 400 and the printer 300 are connected to a local area network 4 (LAN 4). The LAN 4 is a wired network or a wireless network. The LAN 4 is connected to the internet 6. The service server 10 and the account server 100 are connected to the internet 6. The service server 10 and the account server 100 are communicable with devices within the LAN 4 (e.g., the terminal device 400) via the internet 6. The service server 10 is also communicable with the account server 100 via the internet 6. The service server 10 and the account server 100 are established on the internet 6, for example, by the vendor of the printer 300.

### Configuration of Service Server 10: FIG. 2

The service server 10 is a server for providing a subscription service for the printer 300. The subscription service charges only a base fee when the number of sheets used for printing within a unit period (e.g., one month) is equal to or less than the upper limit (e.g., 100 sheets), while when the number of sheets used for printing within the unit period exceeds the upper limit, the subscription service charges the sum of the base fee and an additional fee for the sheets exceeding the upper limit. The subscription service includes an automatic shipping service. The automatic shipping service is a service for automatically shipping a new cartridge when a remaining amount of color material (e.g., ink, toner) in a color material cartridge mounted in the printer 300 becomes equal to or less than a predetermined amount. The cartridge price is included in the base fee of the subscription service. Hereinafter, a color material cartridge is abbreviated as “CTG”.

The service server 10 comprises a communication interface 20 and a controller 30. Hereinafter, an interface is abbreviated as “I/F”. The communication I/F 20 is an I/F for communication via the internet 6 and is connected to the internet 6.

The controller 30 comprises a CPU 32 and a memory 34. The memory 34 comprises, for example, a volatile memory and a non-volatile memory. The CPU 32 executes various processes according to a program 36 stored in the memory 34.

A service table 38 is stored in the memory 34. The service table 38 stores information for providing the subscription service. In the service table 38, management identifiers, serial numbers, numbers of sheets used for printing, and benefit granting information are stored in association with each other. Each management identifier is used for cooperation with the account server 100 and is shared between the service server 10 and the account server 100. The management identifiers are issued, for example, by the service server 10. One management identifier is issued for each account information. The serial numbers are numbers for identifying printers. In the service table 38, one or more serial numbers are associated with each management identifier. The number of sheets used for printing is a total of sheets used for printing within the unit period in a printer identified by the associated serial number. Each benefit granting information indicates that a benefit has been granted to a user of the subscription service. The benefit may include, for example, giving additional sheets to the upper limit based on which the additional fee charge is determined (e.g., giving 10 additional sheets) and discounting the base fee. The benefit may include awarding points available in a predetermined point accumulation program. The points can be used to pay the subscription service fees. The predetermined point accumulation program may be provided by the vendor of the printer 300 or by a different entity than the vendor of the printer 300. For example, the entity may be a vendor on an electric commerce (EC) site. The benefit may include giving free consumable articles, for example, such as CTGs, print paper. Each benefit granting information indicates the content of a granted benefit, such as 10 additional sheets. If no benefits have been granted, the benefit granting information indicates that no benefits have been granted. In a modification, the benefit granting information may be a flag that selectively indicates either a value indicating that a benefit has been granted or a value indicating that no benefits have been granted.

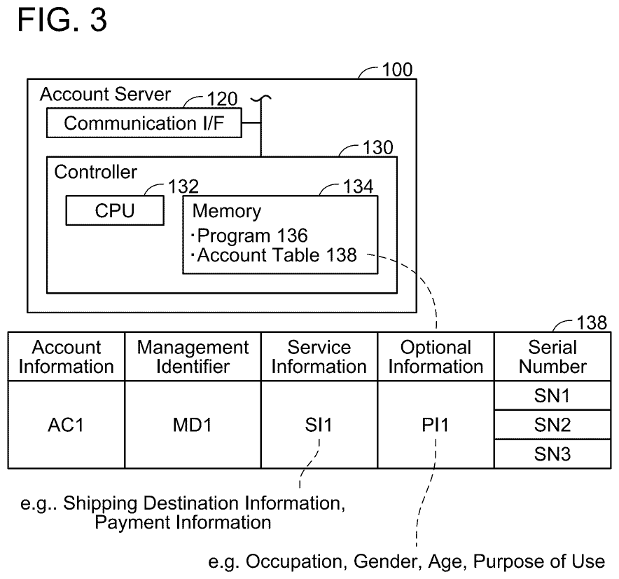

### Configuration of Account Server 100: FIG. 3

The account server 100 manages user-related information. The account server 100 comprises a communication I/F 120 and a controller 130. The communication I/F 120 is connected to the internet 6. The controller 130 comprises a CPU 132 and a memory 134. The CPU 132 executes various processes according to a program 136 stored in the memory 134.

An account table 138 is stored in the memory 134. The account table 138 stores user information for each of multiple users. In the account table 138, user's account information (e.g., account names), management identifiers, service information, optional information, and serial numbers are associated with each other. Each service information is information necessary for provision of the subscription service. The service information includes, for example, shipping destination information indicating a destination address to which a CTG is shipped via the subscription service, payment information used to pay the subscription service fees, a user's e-mail address. The payment information is, for example, a credit card number. The user can select whether to register optional information in the account server 100 or not. Each optional information includes a plurality of items. The plurality of items may include, for example, a user's occupation, sex, age, and purpose of using the printer. The service server 10 can provide the subscription service even when optional information is not stored in the account table 138.

In the account table 138, one or more serial numbers are associated with each account information. The serial numbers in the account table 138 identify one or more printers used by the user of the account information. The number of serial numbers in the service table 38 may not be the same as the number of serial numbers in the account table 138. For example, in the examples of FIGS. 2 and 3, a serial number SN3 is in the account table 138 but not in the service table 38. This means that the user uses the printer 300 identified by the serial number SN3 but does not receive the subscription service for the printer 300 identified by the serial number SN3.

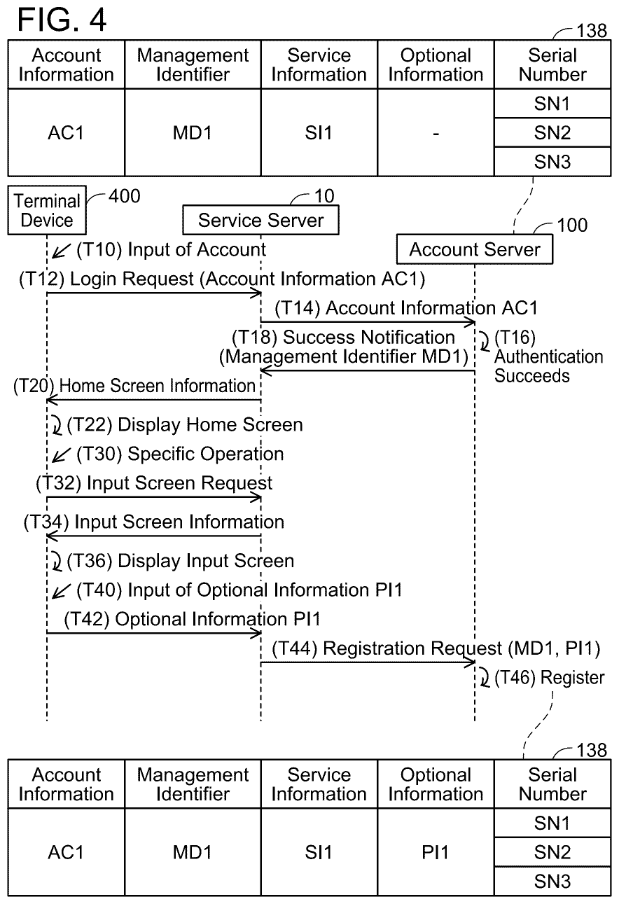

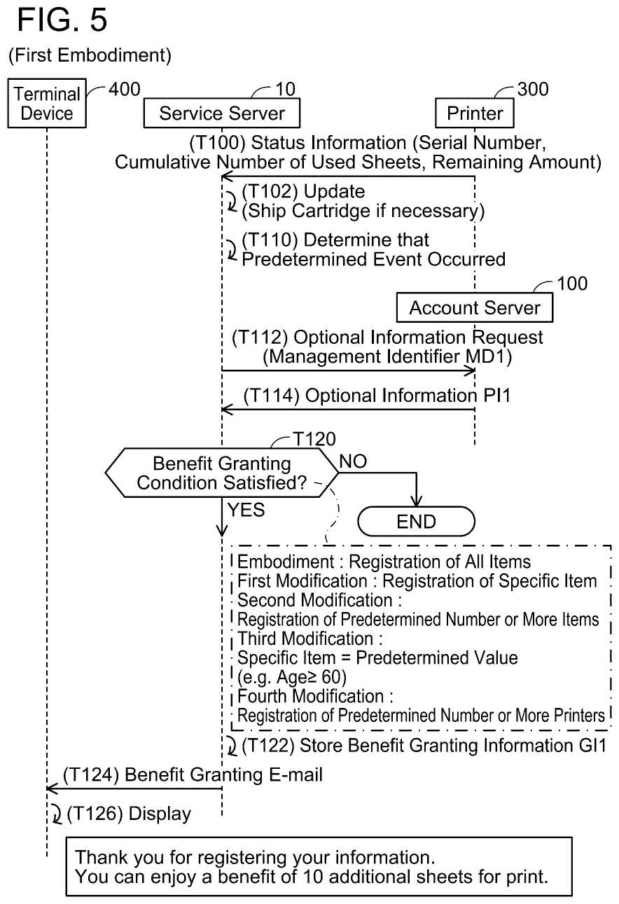

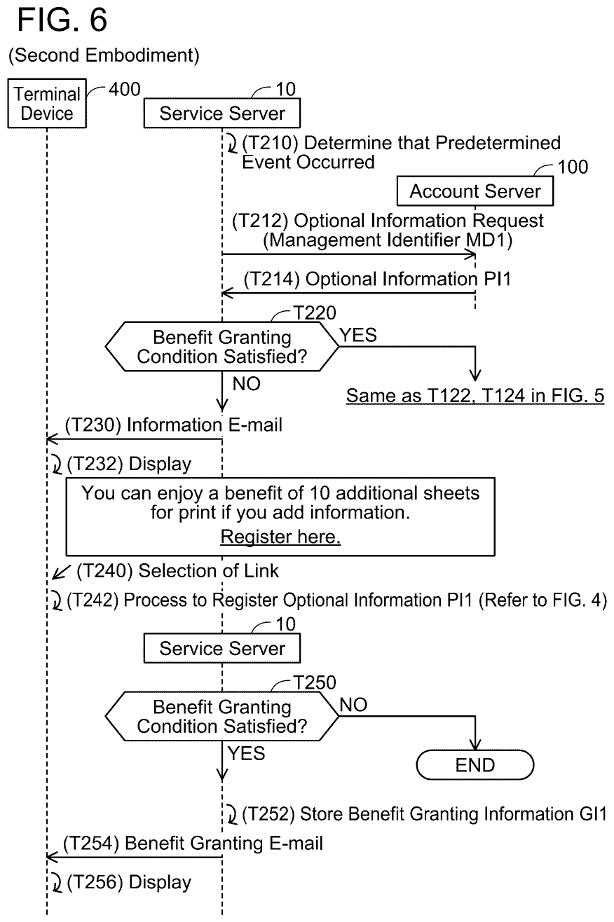

### Registration of Optional Information: FIG. 4

Referring to FIG. 4, a process for registering optional information in the account server 100 is described. In the initial state of the process of FIG. 4, the user has already subscribed to the subscription service for two printers 300 identified by serial numbers SN1 and SN2. In response to the subscription service being subscribed to, a management identifier MD1 has been issued by the service server 10 and the serial numbers SN1 and SN2 are already stored in the service table 38 (see FIG. 2). Further, in the initial state of FIG. 4, service information SI1 is already stored in the account table 138 in association with account information AC1, while no optional information is stored in association with the account information AC1 in the account table 138. Hereinafter, to facilitate understanding, steps performed by the CPUs of devices (e.g., the CPU 32 of the service server 10) are described as if the devices themselves performed the steps.

In T10, the terminal device 400 receives input of the account information AC1 from the user. In T12, the terminal device 400 sends the service server 10 a login request to request a login to the service server 10. The login request includes the account information AC1 which was input in T10.

In response to receiving the login request from the terminal device 400 in T12, the service server 10 sends the account information AC1 included in the login request to the account server 100 in T14.

In response to receiving the account information AC1 from the service server 10 in T14, the account server 100 authenticates the account information AC1. In the present case, the account information AC1 is already stored in the account table 138. The account server 100 thus determines in T16 that the authentication of the account information AC1 has succeeded. Then, the account server 100 sends the service server 10 a success notification to notify the successful authentication of the account information AC1 in T18. The success notification includes the management identifier MD1 associated with the account information AC1 in the account table 138. The terminal device 400 can successfully log in to the service server 10 after the successful authentication of the account information AC1 in the account server 100.

In response to receiving the success notification from the account server 100 in T18, the service server 10 sends home screen information representing a home screen for the subscription service to the terminal device 400 in T20.

In response to receiving the home screen information from the service server 10 in T20, the terminal device 400 displays the home screen represented by the home screen information in T22. In the present case, the user performs a specific operation on the home screen in T30. As a result, an input screen for input of optional information is displayed, and the user can input optional information thereto. That is, the user can input optional information at any timing at which the specific operation is performed.

In response to receiving the specific operation from the user in T30, the terminal device 400 sends the service server 10 an input screen request to request the input screen in T32. In T34, the terminal device 400 receives input screen information representing the input screen from the service server 10 as a response to the input screen request. In T36, the terminal device 400 displays the input screen represented by the input screen information.

In T40, the terminal device 400 receives input of optional information PI1 on the input screen from the user. Here, the user inputs at least one value for at least one item among the plurality of items of optional information. In T42, the terminal device 400 sends the optional information PI1 which was input in T40 to the service server 10.

In response to receiving the optional information PI1 from the terminal device 400 in T42, the service server 10 sends the account server 100 a registration request to request registration of optional information in T44. The registration request includes the optional information PI1 received in T42 and the management identifier MD1.

In response to receiving the registration request from the service server 10 in T44, the account server 100 stores the optional information PI1 in the account table 138 in association with the management identifier MD1 included in the registration request in T46. Thus, the optional information PI1 about the user of the account information AC1 is registered in the account server 100.

### Service Provision and Benefit Granting: FIG. 5

Referring to FIG. 5, a process for providing a service to the user and a process for granting a benefit to the user are described. In the initial state of the present case, the user has already subscribed to the subscription service for the two printers 300 identified by the serial numbers SN1 and SN2. After the subscription service has been subscribed to, the printer 300 starts periodically sending state information indicating the current state of the printer 300 to the service server 10 in T100. The state information includes the serial number of the printer 300, the cumulative number of sheets used for printing in the printer 300 (simply termed “the cumulative number of used sheets” hereinafter), and the remaining amount in a CTG currently mounted in the printer 300.

In response to receiving the state information from the printer 300 in T100, the service server 10 updates the service table 38 in T102 based on the state information received in T100. State information previously received from the printer 300 is in the service server 10. The service server 10 calculates a difference between the cumulative number of used sheets included in the state information received in T100 and the cumulative number of used sheets included in the previously received state information, and then adds the difference to the number of sheets used for printing associated with the serial number included in the state information received in T100.

The service server 10 also determines whether the remaining amount included in the state information received in T100 (i.e., the remaining amount in the CTG) is equal to or less than a predetermined value. When determining that the remaining amount is equal to or less than the predetermined value, the service server 10 executes a process for shipping a new CTG. Specifically, the service server 10 requests the account server 100 to send the service information SI1 and receives the service information SI1 associated with the serial number included in the state information from the account server 100. The service server 10 then outputs an instruction to ship a new CTG to the address indicated by the shipping destination information included in the received service information SI1. This instruction is output, for example, to a terminal used by a worker in charge of CTG shipping. Through the steps of T100 and T102, the subscription service is provided to the user.

In T110, the service server 10 monitors the occurrence of a predetermined event. The occurrence of the predetermined event is a trigger for a sequence from T112 to be executed to grant a benefit to the user. The predetermined event may include, for example, arrival of the time and date at which a benefit becomes available or the number of used sheets within the unit period exceeding a threshold. In a modification, the predetermined event may include completion of the subscription to the subscription service, an elapse of a predetermined period (e.g., one week) from the completion of the subscription to the subscription service, or regular arrival of a period (e.g., one month) after the completion of the subscription to the subscription service.

The service server 10 determines in T110 that the predetermined event has occurred and proceeds to T112. In T112, the service server 10 sends the account server 100 an optional information request to request optional information. The optional information request includes the management identifier MD1. In T114, the service server 10 receives the optional information PI1 associated with the management identifier MD1 included in the optional information request from the account server 100.

In T120, the service server 10 determines whether the optional information PI1 received from the account server 100 satisfies a benefit granting condition. In this embodiment, the benefit granting condition is that values have been registered for all the items of the received optional information PI1. When determining that the optional information PI1 does not satisfy the benefit granting condition (NO in T120), the service server 10 skips a sequence from T112 and ends the process of FIG. 5. In contrast, when determining that the optional information PI1 satisfies the benefit granting condition (YES in T120), the service server 10 proceeds to T122.

In T122, the service server 10 stores benefit granting information GI1 in the service table 38 in association with the management identifier MD1. As above, a benefit is granted to the user of the account information AC1 associated with the management identifier MD1.

In T124, the service server 10 sends a benefit granting e-mail indicating that the benefit has been granted to the e-mail address included in the service information SI1 associated with the management identifier MD1. In this embodiment, the e-mail address included in the service information SI1 has been registered in a mailer of the terminal device 400. In T126, the terminal device 400 displays the benefit granting e-mail. This allows the user to know that the benefit has been granted. In a modification, a short message service (SMS) and/or a social networking service (SNS) may be used instead of the e-mail. In another modification, the service server 10 may send the printer 300 a message indicating that the benefit has been granted, and this message may be displayed on a panel of the printer 300.

### Advantageous Effects of Embodiment

In the configuration according to the embodiment, a benefit is granted to the user in exchange for storing the optional information PI1 (T122 in FIG. 5). The user can use the benefit to use the subscription service more conveniently. Especially, in this embodiment, the benefit is granted to the user in exchange for registering values for all the items. The user recognition on the appeal of the subscription service is promoted.

In a modification 1 of the embodiment, the benefit granting condition includes that a value has been registered for a specific item among all the items of the received optional information PI1. The specific item is, for example, the user's age. In this modification, the benefit granting condition is satisfied even when values are not registered for the other items but the specific item. In this case, a benefit is granted to the user in exchange for registering a value for the specific item.

In a modification 2 of the embodiment, the benefit granting condition includes that values have been registered for a predetermined number of items (e.g., three items) among all the items of the received optional information PI1. In this case, a benefit is granted to the user in exchange for registering values for the multiple items.

In a modification 3 of the embodiment, the benefit granting condition includes that a value registered for a specific item of the received optional information PI1 indicates a predetermined value. For example, the specific item is the user's age, and the predetermined value is 60 or more. In this case, a benefit is granted to users that satisfy a predetermined condition.

Whether the benefit granting condition is satisfied or not may be determined based on information other than optional information. In a modification 4 of the embodiment, the benefit granting condition includes that the number of printers 300 registered in the service table 38 is a predetermined number or more. Specifically, the service server 10 specifies the number of serial numbers associated with the management identifier MD1 in the service table 38. When the specified number of serial numbers is equal to or more than a predetermined number (e.g., three), the service server 10 determines that the benefit granting condition is satisfied. In this case, a benefit is granted to the user in exchange for using the subscription service for the multiple printers 300. In this embodiment, T112 and T114 in FIG. 5 may be omitted.

In another modification, the benefit granting condition may include any combination of at least two benefit granting conditions described in the embodiment and modifications 1 to 4.

### Correspondence Relationships

The service server 10 and the account server 100 are examples of “server”. The memory 34 and the memory 134 are examples of “memory”. The management identifier MD1 and serial numbers are examples of “first-type information”. The serial numbers SN1 and SN2 are examples of “first identification information” and “second identification information”, respectively. The printer 300 with the serial number SN1 and the printer 300 with the serial number SN2 are examples of “first printer” and “second printer”, respectively. The subscription service is examples of “first service” and “second service”. The combination of T100 and T102 in FIG. 5 is examples of “first providing process” and “second providing process”. In the first embodiment and modifications 1 to 3, the optional information PI1 is an example of “second-type information”. In the modification 4, the serial number SN2 is an example of “second-type information”. The benefit granting information GI1 is an example of “benefit granting information”.

T100 and T102 in FIG. 5 are an example of “execute a first providing process”. T122 is an example of “store benefit granting information”.

### Second Embodiment

### Benefit Granting: FIG. 6

This embodiment is the same as the first embodiment except for the process for granting a benefit to the user. A sequence from T210 to T220 is the same as the sequence from T110 to T120 in FIG. 5. When determining that the benefit granting condition is satisfied (YES in T220), the service server 10 executes the same steps as T122 and T124 in FIG. 5, whereas when determining that the benefit granting condition is not satisfied (NO in T220), the service server 10 proceeds to T230.

In T230, the service server 10 sends an information e-mail to notify that a benefit is going to be granted in exchange for registration of optional information to the e-mail address included in the service information SI1 associated with the management identifier MD1. In T232, the terminal device 400 displays the information e-mail.

The information e-mail includes a link to access the service server 10 (e.g., a letter string “Register Here”). The link includes a Uniform Resource Locator (URL) of the service server 10. In the present case, the user selects the link on the information e-mail. When the link on the information e-mail is selected in T240, the terminal device 400 accesses the service server 10 by using the URL included in the link and displays a screen for input of account information. After this, the same sequence from T10 to T46 in FIG. 4 is executed in T242 to register the optional information PI1 in the account server 100. In a modification, the information e-mail may not include the link and may simply serve to promote the user recognition on the appeal of the service. In another modification, SMS and/or SNS may be used instead of e-mail. In yet another modification, the service server 10 send the printer 300 a message to notify that a benefit is going to be granted in exchange for registration of optional information, and this message may be displayed on the panel of the printer 300.

A sequence from T250 to T256 are the same as the sequence from T120 to T126 in FIG. 5. In this embodiment, when a benefit is not granted due to the benefit granting condition being not satisfied, information to receive the benefit is presented to the user. This allows the user to recognize how attractive the service is and avoids the user losing an opportunity to receive the benefit. The information e-mail in T230 is an example of “message”.

### Third Embodiment

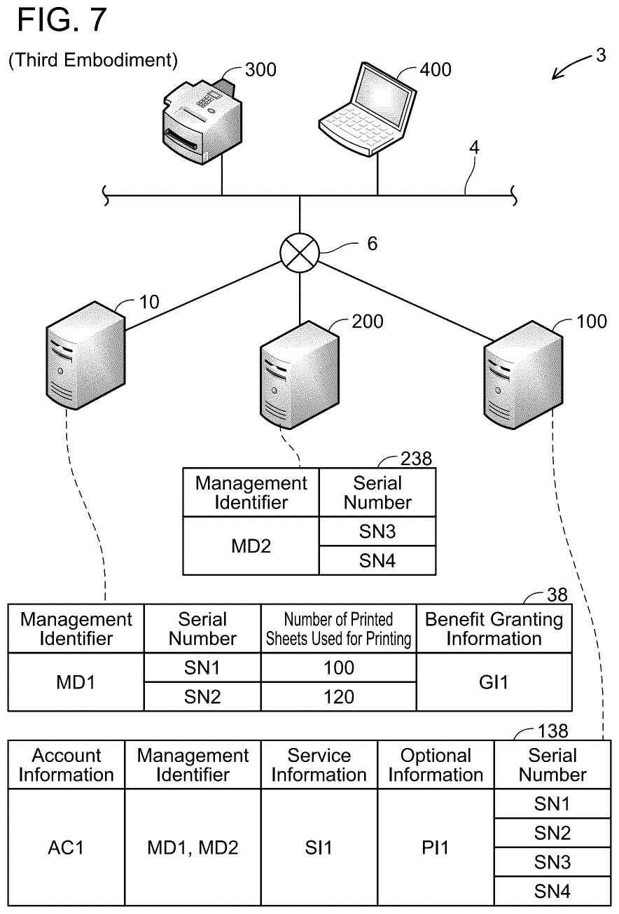

### Configuration of Communication System 3: FIG. 7

In this embodiment, a communication system 3 further comprises a service server 200 in addition to the devices 10, 100, 300, and 400 of the communication system 2 according to the first embodiment. The service server 200 is established on the internet 6. The service server 200 provides a pay-per-use service for the printer 300. The pay-per-use service includes the automatic shipping service for CTGs and charges the price of a cartridge every time a new cartridge is shipped.

The service server 200 stores a service table 238. In the service table 238, various information to provide the pay-per-use service are stored. In the service table 238, management identifiers are associated with serial numbers. The management identifiers in the service table 238 are issued by the service server 200 and shared between the service server 200 and the account server 100.

In this embodiment, the user of the account information AC1 has subscribed not only to the subscription service provided by the service server 10 but also to the pay-per-use service provided by the service server 200. In this embodiment, a management identifier MD2 issued by the service server 200 as well as the management identifier MD1 issued by the service server 10 is associated with the account information AC1 in the account service table 138.

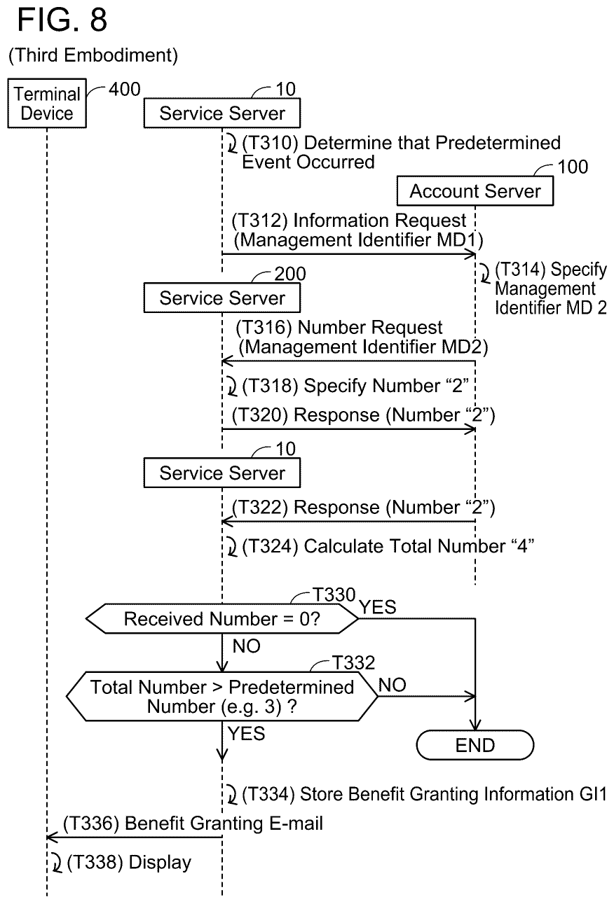

### Benefit Granting: FIG. 8

Referring to FIG. 8, a process to grant a benefit to the user is described. In the initial state of this case, the user has already subscribed to the subscription service for two printers 300 with serial numbers SN1 and SN2 and the pay-per-use service for two printers 300 with serial numbers SN3 and SN4 (see FIG. 7). For the pay-per-use service as well, the same steps as T100 and T102 in FIG. 5 are executed to automatically ship a CTG.

T310 is the same as T110 in FIG. 5. In T312, the service server 10 sends the account server 100 an information request that requests information for the pay-per-use service. The information request includes the management identifier MD1.

In response to receiving the information request from the service server 10 in T312, the account server 100 specifies the management identifier MD2 associated with the same account information AC1 with which the management identifier MD1 in the information request is associated in the account table 138 in T314. In T316, the account server 100 sends the service server 200 a number request that requests the number of printers 300 registered for the pay-per-use service. The number request includes the management identifier MD2 specified in T314.

In response to receiving the number request from the account server 100 in T316, the service server 200 specifies the number of serial numbers stored in the service table 238 in association with the management identifier MD2 included in the number request in T318. In the present case, the number “2” is specified. In T320, the service server 200 sends the account server 100 a response including the number “2” specified in T318 as a response to the number request.

In response to receiving the response from the service server 200 in T320, the account server 100 sends the service server 10 a response to the information request of T312 in T322. The response of T322 includes the number “2” included in the response of T320.

In response to receiving the response from the account server 100 in T322, the service server 10 specifies the number of serial numbers associated with the management identifier MD1 in the service table 38. In the present case, the number “2” is specified. In following T324, the service server 10 adds the number received in T322 to the number specified in the service table 38 to calculate a total number. In the present case, the total number calculated is “4”.

In T330, the service server 10 determines whether the number received in T322 is “0”. When determining that the number received n T322 is “0” (YES in T330), the service server 10 skips a sequence from T332 and ends the process of FIG. 8. In contrast, when determining that the number received in T322 is not “0” (NO in T330), the service server 10 proceeds to T332.

In T332, the service server 10 determines whether the total number calculated in T324 is larger than a predetermined number. In the present case, the predetermined number is “3”. In the present case, the service server 10 determines that the total number “4” is larger than the predetermined number “3” (YES in T332) and proceeds to T334. A sequence from T334 to T338 is the same as the sequence from T122 to T126 in FIG. 5. When determining that the total number is equal to or smaller than the predetermined number (NO in T332), the service server 10 skips the sequence from T334 and ends the process of FIG. 8. The predetermined number is not limited to 3 and may be any number other than 3, such as 4 or 2.

In this embodiment, the benefit grating information GI1 is stored in the service table 38 when the total number of the printers 300 using the subscription service and the printers 300 using the pay-per-use service is larger than the predetermined number (NO in T330 of FIG. 8, T332). A benefit is granted to the user in exchange for the use of both the subscription service and the pay-per-use service for many printers 300.

### Correspondence Relationships

The subscription service and the pay-per-use service are examples of “first service” and “second service”, respectively. The serial number SN1 and the serial number SN3 are examples of “first identification information” and “second identification information”, respectively. The serial numbers in the service table 238 are examples of “second-type information”. The memories 34, 134 and the memory of the service server 200 are examples of “memory”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

### Modification 5

In the first and second embodiments, the functions of the service server 10 and the account server 100 may be implemented by a single server. In the third embodiment, the functions of the service servers 10 and 200 and the account server 100 may be implemented by a single server. In this modification, the single server is an example of “server”.

### Modification 6

The “first service” may be the pay-per-use service or another service other than the subscription service and the pay-per-use service. The other service is, for example, a service of managing the current state of the printer 300. The “second service” may be the subscription service or another service. Generally, the “first service” and “second service” may be any services as long as they are for printers.

### Modification 7

In the above embodiments, the processes of FIGS. 5, 6, and 8 are implemented by the CPUs 32 ad 132 executing the programs 36 and 136. Instead, one or more of these processes may be implemented by hardware such as a logic circuit.

What is claimed is:

1. A server, comprising:
a controller configured to:
execute a first providing process by using first-type information stored in a memory, wherein the first providing process is a process for providing a first service for a first printer identified by first identification information included in the first-type information; and
in a case where second-type information different from the first-type information is stored in the memory in association with the first-type information, store benefit granting information in the memory in association with the first-type information, wherein the benefit granting information indicates that a benefit has been granted to a user of the first service.

2. The server according to claim 1, wherein
the second-type information is specific information which is one of two or more information that are optionally stored in the memory.

3. The server according to claim 1, wherein
the second-type information is optional information that is optionally stored in the memory, and
the controller is configured to store the benefit granting information in the memory in a case where a number of the optional information stored in the memory as the second-type information becomes equal to or more than a predetermined number.

4. The server according to claim 1, wherein
the controller is configured to store the benefit granting information in the memory in a case where the second-type information is stored in the memory and the second-type information indicates a predetermined content.

5. The server according to claim 1, wherein
the second-type information includes second identification information for identifying a second printer different from the first printer, and
the controller is further configured to:
execute a second providing process by using the second-type information stored in the memory, wherein the second providing process is a process for providing a second service for the second printer identified by the second identification information included the second-type information.

6. The server according to claim 5, wherein
the second service is a service of the same type as the first service.

7. The server according to claim 5, wherein
the second service is a service of different type from the first service.

8. The server according to claim 1, wherein
the controller is configured to store the benefit granting information in the memory in a case where a number of identification information including the first identification information and the second identification information in the memory becomes equal to or more than a predetermined number, wherein the predetermined number is two or more.

9. The server according to claim 1, wherein
the controller is further configured to:
in a case where the second-type information is not in the memory, notify a user of a message that prompts the user to store the second-type information in the memory.

10. The server according to claim 1, wherein
the first service is a service of shipping a consumable article for the first printer.

11. The server according to claim 1, wherein
the first service is a subscription service, and
the subscription service has an upper limit of the number of sheets used for printing within an unit period.

12. The server according to claim 11, wherein
the benefit is additional sheets added to the upper limit.

13. A non-transitory computer-readable recording medium storing computer-readable instructions for a server, the computer-readable instructions, when executed by a processor of the server, causing the server to:
execute a first providing process by using first-type information stored in a memory, wherein the first providing process is a process for providing a first service for a first printer identified by first identification information included in the first-type information; and
in a case where second-type information different from the first-type information is stored in the memory in association with the first-type information, store benefit granting information in the memory in association with the first-type information, wherein the benefit granting information indicates that a benefit has been granted to an user of the first service.

14. A control method for a server, the control method comprising:
executing a first providing process by using first-type information stored in a memory, wherein the first providing process is a process for providing a first service for a first printer identified by first identification information included in the first-type information; and
in a case where second-type information different from the first-type information is stored in the memory in association with the first-type information, storing benefit granting information in the memory in association with the first-type information, wherein the benefit granting information indicates that a benefit has been granted to an user of the first service.
